(19) United States
(12) Patent Application Publication
(10) Pub. No.: US 2015/0009295 A1
(43) Pub. Date: Jan. 8, 2015

(54) THREE-DIMENSIONAL IMAGE ACQUISITION APPARATUS AND IMAGE PROCESSING METHOD USING THE SAME

(71) Applicant: Electronics and Telecommunications Research Institute, Daejeon (KR)

(72) Inventors: Nacwoo KIM, Gwangju (KR); Seungchul SON, Gwangju (KR); Jaein KIM, Gwangju (KR); Byungtak LEE, Suwon (KR); Youngsun KIM, Daejeon (KR)

(21) Appl. No.: 14/306,136

(22) Filed: Jun. 16, 2014

(30) Foreign Application Priority Data
Jul. 3, 2013 (KR) 10-2013-0077956

(51) Int. Cl. H04N 13/02; H04N 5/33

(52) U.S. Cl. CPC H04N 13/0239; H04N 5/33
USPC 348/47

(57) ABSTRACT

Disclosed herein are a 3D image acquisition apparatus and an image processing method using the apparatus, which combine an infrared sensor-based camera with a binocular camera, and simultaneously perform zoom-in (close-up) photographing and zoom-out photographing while processing depth-based 3D images. The proposed 3D image acquisition apparatus includes photographing unit for capturing binocular images via a plurality of cameras and capturing an RGB image and a depth image based on an infrared sensor, and image acquisition unit for correcting at least one pair of images among the binocular images and the RGB image, based on whether to use the depth image captured by the photographing unit, and then acquiring images to be provided to a user.

### CROSS REFERENCE TO RELATED APPLICATION

This application claims the benefit of Korean Patent Application No. 10-2013-0077956 filed on Jul. 3, 2013, which is hereby incorporated by reference in its entirety into this application.

### BACKGROUND OF THE INVENTION

1. Technical Field

The present invention relates generally to a three-dimensional (3D) image acquisition apparatus and an image processing method using the apparatus and, more particularly, to a 3D image acquisition apparatus and an image processing method using the apparatus, which provide a 3D image to a user using images captured by an infrared sensor-based camera module and a binocular camera module.

2. Description of the Related Art

Recently, a variety of application programs and devices for providing various services using 3D stereoscopic images have been developed. In this case, 3D stereoscopic images are captured by an infrared sensor-based camera or binocular cameras.

Examples based on an infrared sensor device include Microsoft's Kinect described in U.S. Pat. No. 8,123,622 (entitled “Lens accessory for video game sensor device”), ASUS's Xtion, etc. Such an infrared sensor-based application program has rapidly replaced the area of existing expensive Light Detection And Ranging (LIDAR) devices, and has very robust characteristics in the acquisition of depth images, especially in, indoor and night environments.

However, in an outdoor environment, there is a limitation in infrared sensors caused by sunlight, and thus LIDAR devices or binocular camera devices are still widely used in a bright outdoor environment.

With the advent of various camera support devices and associated image processing devices, binocular camera devices have been gradually automated by departing from a past operation environment in which a user manually controlled a convergence angle, a focal length, etc. For example, Korean Patent No. 10-0972572 (entitled “Binocular stereoscopic imaging camera device and an apparatus for mounting the camera”) discloses technology for acquiring high-quality 3D stereoscopic images using two binocular cameras.

However, such a binocular camera device is problematic in that different supports must be used to capture images depending on the distance to an object of interest in such a way that a horizontal camera support must be used for zoom-out photographing and an orthogonal camera support must be used for zoom-in (close-up) photographing, and in that only disparity between two RGB stereoscopic images must be used as information upon extracting a depth image of the object of interest.

### SUMMARY OF THE INVENTION

Accordingly, the present invention has been made keeping in mind the above problems occurring in the prior art, and an object of the present invention is to provide a 3D image acquisition apparatus and an image processing method using the apparatus, which combine an infrared sensor-based camera with a binocular camera, and simultaneously perform zoom-in (close-up) photographing and zoom-out photographing while processing depth-based 3D images.

That is, the present invention is intended to provide a method in which an infrared sensor device and a binocular camera device are combined with each other in a hybrid manner, so that an infrared sensor device and a binocular camera device are individually calibrated and installed on a single camera support having an upper surface and a lower surface, and in which images for close-up photographing and images for zoom-out photographing can be alternately selected in real time, via the mutual matching of feature points between depth image/RGB images acquired by the infrared sensor device and two RGB images acquired by the binocular camera device, and a camera suitable for spot photographing is automatically selected upon performing indoor/outdoor photographing.

Another object of the present invention is to provide a new type of camera mount support in which an upper surface support and a lower surface support are integrated and constructed to simultaneously acquire different types of 3D images by departing from an existing scheme in which a support on which a 3D photographing camera is mounted is independently operated upon acquiring stereoscopic images and infrared images.

A further object of the present invention is to provide a 3D image capturing apparatus and an image processing method using the apparatus, in which a binocular camera is mounted on one surface of a support and an infrared sensor device is mounted on the other surface thereof to automatically and simultaneously provide a 3D depth image and a binocular 3D image.

In accordance with an aspect of the present invention to accomplish the above objects, there is provided a three-dimensional (3D) image acquisition apparatus, including photographing unit for capturing binocular images via a plurality of cameras and capturing an RGB image and a depth image based on an infrared sensor; and image acquisition unit for correcting at least one pair of images among the binocular images and the RGB image, based on whether to use the depth image captured by the photographing unit, and then acquiring images to be provided to a user.

Preferably, the photographing unit may include a first support; a binocular camera module comprising a first binocular camera arranged on a first surface of the first support and configured to capture a binocular image, and a second binocular camera arranged on the first surface of the first support while being spaced apart from the first binocular camera, and configured to capture a binocular image; a second support provided with a first surface coupled to a second surface of the first support; and an infrared sensor-based camera module comprising an infrared sensor-based camera arranged on a second surface of the second support and configured to capture the depth image and the RGB image.

Preferably, the binocular camera module may further include a first image cable connected at a first end thereof to the first binocular camera and at a second end thereof to the image acquisition unit, and configured to transmit the image captured by the first binocular camera to the image acquisition unit; and a second image cable connected at a first end thereof to the second binocular camera and at a second end thereof to the image acquisition unit, and configured to transmit the image captured by the second binocular camera to the image acquisition unit.

Preferably, the binocular camera module may further include a first communication cable configured to receive parameters from the image acquisition unit; a first shaft arranged on the first surface of the first support and configured to move and rotate the first binocular camera based on the parameters received through the first communication cable; and a second shaft arranged on the first surface of the first support and configured to move and rotate the second binocular camera based on the parameters received through the first communication cable.

Preferably, the infrared sensor-based camera module may further include a third image cable connected at a first end thereof to the infrared sensor-based camera and at a second end thereof to the image acquisition unit, and configured to transmit the depth image and the RGB image captured by the infrared sensor-based camera to the image acquisition unit.

Preferably, the infrared sensor-based camera module may further include a third communication cable configured to receive parameters from the image acquisition unit; and a third shaft arranged on the second surface of the second support and configured to move and rotate the infrared sensor-based camera based on the parameters received through the third communication cable.

Preferably, an interval between the first binocular camera and the second binocular camera may be formed to be wider than an interval between the first binocular camera and an RGB sensor of the infrared sensor-based camera module.

Preferably, an optical axis between the first binocular camera and the second binocular camera may be linearly arranged, and an optical axis between the first binocular camera and an RGB sensor of the infrared sensor-based camera may be linearly arranged, and the optical axis between the first binocular camera and the second binocular camera and the optical axis between the first binocular camera and the RGB sensor may be orthogonal to each other.

Preferably, the image acquisition unit may include an image analysis unit for mutually correcting two of RGB images received from the photographing unit based on whether to use the depth image received from the photographing unit, producing a disparity map based on corrected RGB images and the depth image, and creating an image matching table based on the disparity map; and an image selection unit for selecting images to be provided to the user based on the image matching table.

Preferably, the image analysis unit may determine whether to use the depth image captured by the photographing unit, based on an amount of information included in the depth image.

Preferably, the image analysis unit may be configured to, if it is determined not to use the depth image, mutually correct the binocular images captured by the binocular camera module, or any one of the binocular images captured by the binocular camera module and the RGB image captured by the infrared sensor-based camera module, determine whether to use the corrected images depending on whether the corrected images are aligned with each other, produce a disparity map, and create an image matching table based on the produced disparity map.

Preferably, the image analysis unit may be configured to, if it is determined to use the depth image, mutually correct the binocular images captured by the binocular camera module, or any one of the binocular images captured by the binocular camera module and the RGB image captured by the infrared sensor-based camera module, match feature points between objects of the images based on depth information detected from the depth image, produce a disparity map, and create an image matching table based on the produced disparity map.

Preferably, the image selection unit may calculate parameter values based on images included in image combination selection information input from a 3D image display device, and the image acquisition unit may further include a parameter adjustment unit for transmitting the parameter values detected by the image selection unit to the binocular camera module and the infrared sensor-based camera module, and calibrating the binocular camera module and the infrared sensor-based camera module.

In accordance with another aspect of the present invention to accomplish the above objects, there is provided an image processing method using a 3D image acquisition apparatus, including capturing, by photographing unit, binocular images via a plurality of binocular cameras and capturing an RGB image and a depth image via an infrared sensor-based camera; analyzing, by image acquisition unit, the captured binocular images, RGB image, and depth image, and detecting images to be provided to a user; and transmitting, by the image acquisition unit, the detected images to a 3D image display device.

Preferably, capturing may include capturing, by the photographing unit, two binocular images; capturing, by the photographing unit, the RGB image and the depth image; and transmitting, by the photographing unit, the captured two binocular images, RGB image, and depth image to the image acquisition unit.

Preferably, detecting may include determining, by the image acquisition unit, whether to use the depth image received from the photographing unit, wherein determining is configured to determine whether to use the depth image, based on an amount of information included in the depth image.

Preferably, detecting may further include, if it is determined to use the depth image at determining, mutually correcting, by the image acquisition unit, two images of the binocular images and the RGB image; matching, by the image acquisition unit, feature points between objects of the images, based on the depth information detected from the depth image; and creating, by the image acquisition unit, an image matching table based on a disparity map produced from the matched feature points between the objects.

Preferably, detecting may further include, if it is determined not to use the depth image at determining, mutually correcting, by the image acquisition unit, two images of the binocular images and the RGB image; determining, by the image acquisition unit, whether to use the corrected images, depending on whether the corrected images are aligned with each other, and then producing a disparity map; and creating, by the image acquisition unit, an image matching table based on the produced disparity map.

Preferably, the image processing method may further include calibrating, by the image acquisition unit, the plurality of binocular cameras and the infrared sensor-based camera.

Preferably, wherein calibrating may further include receiving, by the image acquisition unit, image combination selection information from the 3D image display device; detecting, by the image acquisition unit, parameter values required to calibrate the plurality of binocular cameras and the infrared sensor-based camera, from images included in the received image combination selection information; and transmitting, by the image acquisition unit, the detected parameter values to the photographing unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a 3D image acquisition apparatus according to an embodiment of the present invention;

FIGS. 2 to 4 are diagrams showing the photographing unit of FIG. 1;

FIG. 5 is a block diagram showing the image acquisition unit of FIG. 1;

FIG. 6 is a flowchart showing a 3D image acquisition method according to an embodiment of the present invention;

FIG. 7 is a flowchart showing the RGB image and depth image capturing step of FIG. 6; and

FIGS. 8 and 9 are flowcharts showing the image analysis and detection step of FIG. 6.

### DESCRIPTION OF THE PREFERRED EMBODIMENTS

Embodiments of the present invention are described with reference to the accompanying drawings in order to describe the present invention in detail so that those having ordinary knowledge in the technical field to which the present invention pertains can easily practice the present invention. It should be noted that same reference numerals are used to designate the same or similar elements throughout the drawings. In the following description of the present invention, detailed descriptions of known functions and configurations which are deemed to make the gist of the present invention obscure will be omitted.

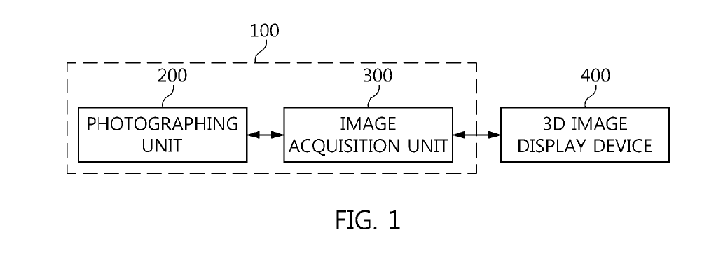

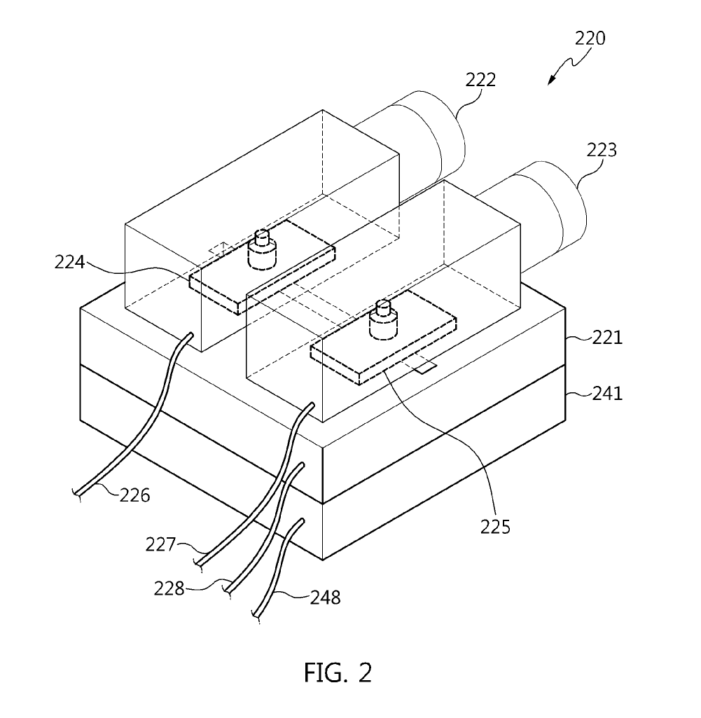

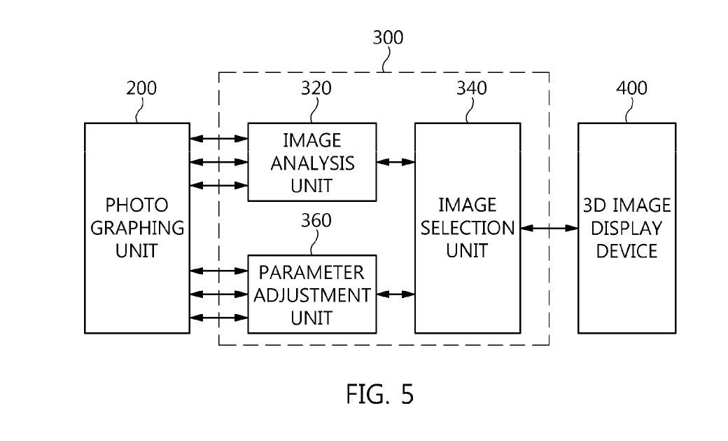

Hereinafter, a 3D image acquisition apparatus according to an embodiment of the present invention will be described in detail with reference to the attached drawings. FIG. 1 is a block diagram showing a 3D image acquisition apparatus according to an embodiment of the present invention. FIGS. 2 to 4 are diagrams showing the photographing unit of FIG. 1, and FIG. 5 is a block diagram showing the image acquisition unit of FIG. 1.

As shown in FIG. 1, a 3D image acquisition apparatus 100 is configured to include a photographing unit 200 for capturing a depth image and RGB images via an infrared sensor and a binocular camera, and an image acquisition unit 300 for acquiring images to be provided to a user via a 3D image display device 400 using the depth image and the RGB images captured by the photographing unit 200.

The photographing unit 200 includes a binocular camera and an infrared sensor-based camera 242. That is, the photographing unit 200 includes a binocular camera module 220 for capturing binocular images and an infrared sensor-based camera module 240 for capturing a depth image. In this case, the binocular camera module 220 and the infrared sensor-based camera module 240 will be described in detail below with reference to the attached drawings.

As shown in FIG. 2, the binocular camera module 220 is configured such that a pair of binocular cameras (that is, a first binocular camera 222 and a second binocular camera 223) is arranged on one surface of a first support 221. In this case, the other surface of the first support 221 is coupled to one surface of a support on which the infrared sensor-based camera module 240, which will be described later, is arranged.

Shafts required to adjust the rotation and movement of the binocular cameras are disposed between the first support 221 and the binocular cameras. That is, a first shaft 224 is disposed on the one surface of the first support 221, and the first binocular camera 222 is arranged on the top of the first shaft 224. A second shaft 225 is disposed on the one surface of the first support 221 while being spaced apart from the first shaft 224, and the second binocular camera 223 is arranged on the top of the second shaft 225.

The first binocular camera 222 and the second binocular camera 223 are respectively connected to image cables for outputting captured images. A first image cable 226 is connected at one end thereof to the first binocular camera 222 and at the other end thereof to the image acquisition unit 300, and transmits a binocular image captured by the first binocular camera 222 to the image acquisition unit 300. A second image cable 227 is connected at one end thereof to the second binocular camera 223 and at the other end thereof to the image acquisition unit 300, and transmits a binocular image captured by the second binocular camera 223 to the image acquisition unit 300.

A first communication cable 228 required to control the pair of binocular cameras and the shafts is connected to the first support 221. In this case, the first communication cable 228 is connected at one end thereof to the first binocular camera 222, the second binocular camera 223, the first shaft 224, and the second shaft 225, and at the other end thereof to the image acquisition unit. In this case, the first communication cable 228 is connected to a driving device (not shown) included in each of the first shaft 224 and the second shaft 225. By means of this, the first communication cable 228 transfers external parameters and internal parameters, input from the image acquisition unit, to the first binocular camera 222, the second binocular camera 223, the first shaft 224, and the second shaft 225. Here, the external parameters, which are parameters required to control external factors such as the movement and rotation of the binocular cameras, are composed of signals required to control the InterOcular Distance (IOD) of the first support 221, convergence angle, camera movement, etc. The internal parameters, which are parameters required to control the internal factors of the binocular cameras, are composed of signals required to control a focal length, photographing settings, etc.

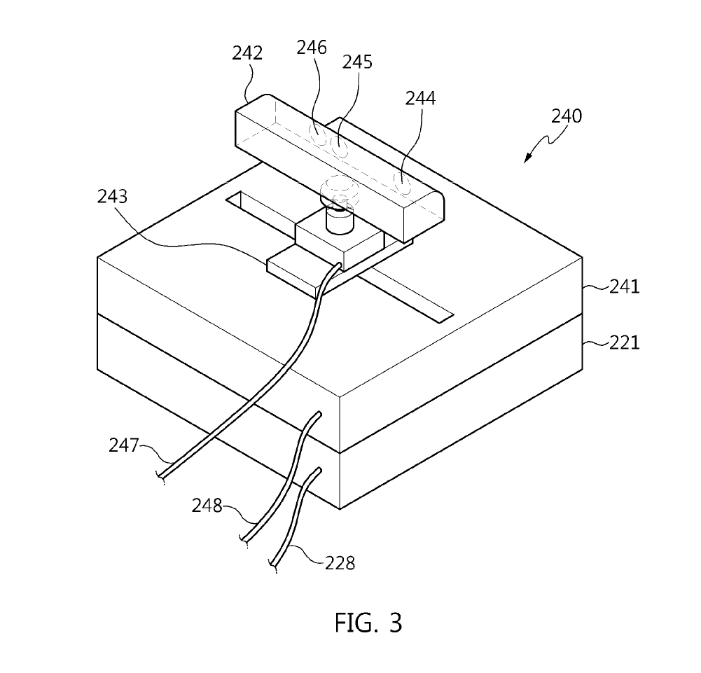

As shown in FIG. 3, the infrared sensor-based camera module 240 is configured such that an infrared sensor-based camera 242 is arranged on one surface of the second support 241. In this case, the other surface of the second support 241 is coupled to one surface of the support (that is, the first support 221) on which the above-described binocular cameras are arranged.

A third shaft 243 required to adjust the rotation and movement of the infrared sensor-based camera 242 is disposed between the second support 241 and the infrared sensor-based camera 242. That is, the third shaft 243 is disposed on one surface of the second support 241, and the infrared sensor-based camera 242 is arranged on the top of the third shaft 243.

The infrared sensor-based camera 242 includes an infrared radiator 244, an RGB sensor 245, and an infrared receiver 246, and captures a depth image and an RGB image. In this case, a third image cable 247 for outputting the captured depth image and RGB image is connected to the infrared sensor-based camera 242. That is, the third image cable 247 is connected at one end thereof to the infrared sensor-based camera 242 and at the other end thereof to the image acquisition unit 300, and transmits the depth image and the RGB image captured by the infrared sensor-based camera 242 to the image acquisition unit 300.

A second communication cable 248 required to control the infrared sensor-based camera 242 and the third shaft 243 is connected to the second support 241. In this case, the second communication cable 248 is connected at one end thereof to the infrared sensor-based camera 242 and the third shaft 243 and at the other end thereof to the image acquisition unit. Here, the second communication cable 248 is connected to a driving device (not shown) included in the second shaft 225. By means of this, the second communication cable 248 transfers external parameters and internal parameters, input from the image acquisition unit, to the infrared sensor-based camera 242 and the second shaft 225. Here, the external parameters, which are parameters for controlling external factors such as the movement and rotation of the infrared sensor-based camera 242, are composed of signals required to control the movement and rotation of the infrared sensor-based camera 242. The internal parameters, which are parameters required to control the internal factors of the infrared sensor-based camera 242, are composed of signals required to control a focal length, photographing settings, etc.

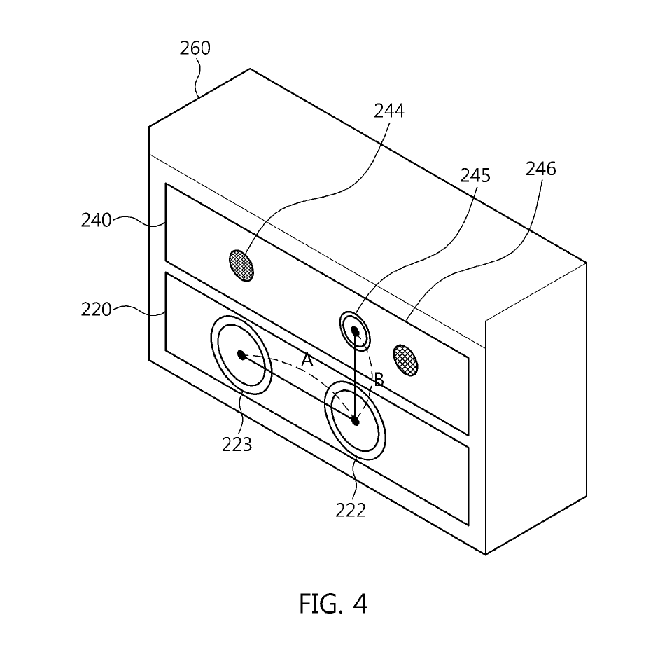

As shown in FIG. 4, the binocular camera module 220 and the infrared sensor-based camera module 240 are arranged in lower and upper portions, respectively, as the corresponding surfaces of the first support 221 and the second support 241 are coupled to each other. In order to perform close-up photographing, the binocular camera module 220 and the infrared sensor-based camera module 240 are arranged such that an interval (that is, A of FIG. 4) between the first binocular camera 222 and the second binocular camera 223 is wider than an interval (that is, B of FIG. 4) between the first binocular camera 222 and the RGB sensor 245 of the infrared sensor-based camera module 240. In particular, since a vertical optical axis and a horizontal optical axis must be individually aligned so as to configure orthogonal images or parallel images, an optical axis (A of FIG. 4) between the first binocular camera 222 and the second binocular camera 223 is linearly arranged and an optical axis (that is, B of FIG. 4) between the first binocular camera 222 and the RGB sensor 245 is linearly arranged. In this case, the optical axis (that is, A of FIG. 4) between the first binocular camera 222 and the second binocular camera 223 and the optical axis (that is, B of FIG. 4) between the first binocular camera 222 and the RGB sensor 245 are arranged to be orthogonal to each other. Although the image acquisition unit 300 is not shown in FIG. 4, it may be contained in a housing 260 in the form of a circuit board or a chip device.

The image acquisition unit 300 detects images to be provided to the user using the images captured by the photographing unit 200, and transmits the detected images to the 3D image display device 400. In this case, the image acquisition unit 300 detects a plurality of images from the binocular images (that is, two RGB images) captured by the binocular camera module 220 and the depth image and the RGB image captured by the infrared sensor-based camera module 240. The image acquisition unit 300 corrects the plurality of detected images, acquires the images to be provided to the user, and transmits the acquired images to the 3D image display device 400.

For this, as shown in FIG. 5, the image acquisition unit 300 includes an image analysis unit 320, an image selection unit 340, and a parameter adjustment unit 360.

The image analysis unit 320 receives images from the photographing unit 200. That is, the image analysis unit 320 receives binocular images (that is, two RGB images) captured by the binocular camera module 220, and the depth image and the RGB image captured by the infrared sensor-based camera module 240.

The image analysis unit 320 determines whether to use the depth image input from the infrared sensor-based camera module 240. That is, the information of the depth image may differ depending on a photographing environment. For example, a depth image has a high contrast ratio and contains a larger amount of information when an object of interest is present within a predefined certain range in an indoor environment. In contrast, in an outdoor environment, a contrast ratio is barely present, and acquired information is almost unavailable. The image analysis unit 320 determines whether to use the depth image, based on the difference in the information of the depth image. Here, the image analysis unit 320 determines whether to use the depth image, based on the preset amount of information. That is, if the amount of information included in the depth image exceeds the preset amount of information, it is determined to use the corresponding depth image. Accordingly, the image analysis unit 320 determines to use the images (that is, the depth image and the RGB image) captured by the infrared sensor-based camera module 240 in an indoor area, and to use images (that is, the two RGB images) captured by the binocular camera module 220 in an outdoor area.

The image analysis unit 320 corrects the selected images based on the results of the determination of whether to use a depth image. The image analysis unit 320 determines whether to use the images by comparing the corrected images, thus enabling at least one of a stereoscopic image for zoom-in (close-up) photographing and a stereoscopic image for zoom-out photographing to be utilized.

This procedure will be described in greater detail below. If it is determined not to use the depth image, the image analysis unit 320 corrects two RGB images captured by the binocular camera module 220 and the RGB image captured by the infrared sensor-based camera module 240. That is, the image analysis unit 320 processes mutual correction between two RGB images respectively captured by the first binocular camera 222 and the second binocular camera 223 or between two RGB images respectively captured by the first binocular camera 222 and the RGB sensor 245 of the infrared sensor-based camera module 240. Here, the image analysis unit 320 extracts camera parameters for any one RGB image via the matching of feature points between the two RGB images. The image analysis unit 320 corrects information such as the scale and rotation of the corresponding RGB image so that the RGB image has the same scale and rotation as those of the other RGB image based on the extracted camera parameters.

The image analysis unit 320 determines whether to use the corrected images, based on information about whether the corrected images are aligned with each other. That is, the image analysis unit 320 determines to use the corrected images as a stereoscopic image if the corrected images are aligned with each other. The image analysis unit 320 determines not to use the corrected images as a stereoscopic image if the corrected images are not aligned with each other. In this case, since the RGB images captured by the first binocular camera 222 and the second binocular camera 223 may always be aligned with each other via calibration, the image analysis unit 320 analyzes only whether the images captured by the first binocular camera 222 and the RGB sensor 245 are aligned with each other.

The image analysis unit 320 produces a disparity map by comparing the corrected images with each other. The image analysis unit 320 sets the produced disparity map to the depth information of the images. In this case, the image analysis unit 320 compares all global features of the corrected images with each other, and produces a disparity map.

Meanwhile, if the image analysis unit 320 determines to use the depth image, the image analysis unit 320 corrects the two RGB images captured by the binocular camera module 220 and the RGB image captured by the infrared sensor-based camera module 240. That is, the image analysis unit 320 processes mutual correction between two RGB images respectively captured by the first binocular camera 222 and the second binocular camera 223 or between two RGB images respectively captured by the first binocular camera 222 and the RGB sensor 245 of the infrared sensor-based camera module. Here, the image analysis unit 320 detects depth information from the depth image. The image analysis unit 320 divides each of images to be compared with each other into individual objects of interest, based on the detected depth information, and matches feature points between the objects of the respective images. The image analysis unit 320 produces a disparity map by comparing the feature points between the matched objects with each other. In this regard, the image analysis unit 320 may utilize the depth information as basic verification data (ground truth) upon producing a disparity map between the RGB images captured by the binocular camera module 220. By means of this, correction performed under a condition in which depth information is not present must use all of the global features of the images, but if the depth information is present, each image may be divided into individual objects of interest, and feature points between the objects in the RGB images may be matched, thus enabling correction to be more elaborately processed.

The image analysis unit 320 creates an image matching table, based on the previously produced disparity map. That is, the image analysis unit 320 creates an image matching table based on a disparity map between the RGB images captured by the first binocular camera 222 and the RGB sensor 245, a disparity map between the RGB images captured by the second binocular camera 223 and the RGB sensor 245, and a disparity map between the RGB images captured by the first binocular camera 222 and the second binocular camera 223. Here, the image matching table shows indices indicating whether the corrected images are usable, and indicates the usability of a vertical camera-based binocular image, a horizontal camera-based binocular image, and depth/disparity-based depth images by indices.

The image selection unit 340 selects images to be provided to the user based on the image matching table created by the image analysis unit. In this case, the image selection unit 340 chiefly selects a basic combination, that is, RGB images captured by the binocular camera module 220, and the RGB image and the depth image captured by the infrared sensor-based camera module 240. The image selection unit 340 selects a combination of RGB images captured by the first binocular camera 222 and the RGB sensor 245 so as to perform close-up photographing. The image selection unit 340 may also select a disparity map between the depth image and the RGB images captured by the binocular camera module 220 upon performing indoor photographing.

The image selection unit 340 detects parameter values of at least one of images included in a selected image combination if image combination selection information has been input from the 3D image display device 400.

That is, the image selection unit 340 transmits the selected images to the 3D image display device 400. The 3D image display device 400 receives image combination selection information including two or more of the images transmitted via the user's input. In this case, the 3D image display device 400 receives image combination selection information, such as a combination of binocular images or a combination of a binocular image and a depth image. The 3D image display device 400 transmits the received image combination selection information to the image selection unit 340. Here, since at least one of the images included in the image combination selection information is a corrected image, the image selection unit 340 detects parameter values required to calibrate a camera (that is, the first binocular camera 222, the second binocular camera 223, or the RGB sensor 245) which captured the corrected image. In this case, the image selection unit 340 detects parameter values from the corrected image, and transmits the parameter values to the parameter adjustment unit 360. Here, the parameter values include at least one of internal parameters and external parameters.

The parameter adjustment unit 360 transmits the parameter values received from the image selection unit 340 to calibrate the binocular camera module 220 and the infrared sensor-based camera module 240 to the binocular camera module 220 and the infrared sensor-based camera module 240. That is, the parameter adjustment unit 360 transmits the parameter values received from the image selection unit 340 to the binocular camera module 220 through the first communication cable. The parameter adjustment unit 360 transmits the parameter values received from the image selection unit 340 to the infrared sensor-based camera module 240 through the second communication cable. Accordingly, the binocular camera module 220 and the infrared sensor-based camera module 240 control the shafts and the cameras depending on the received parameter values.

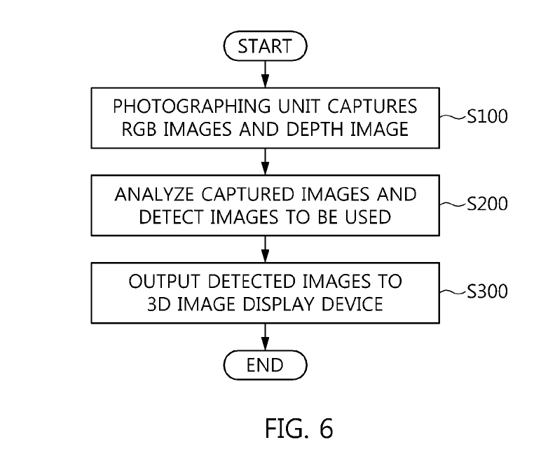

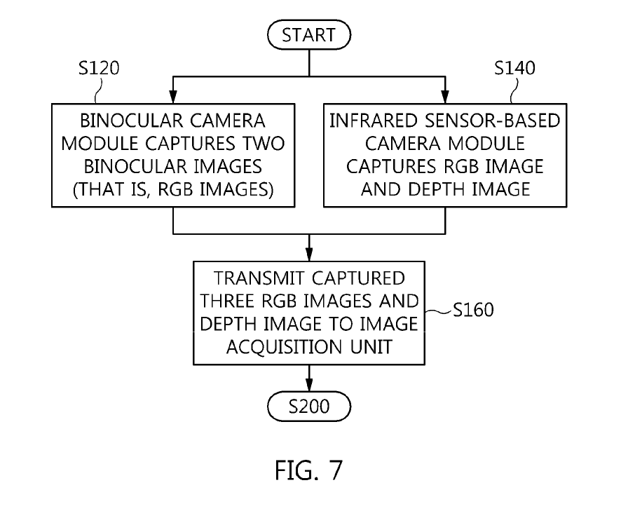

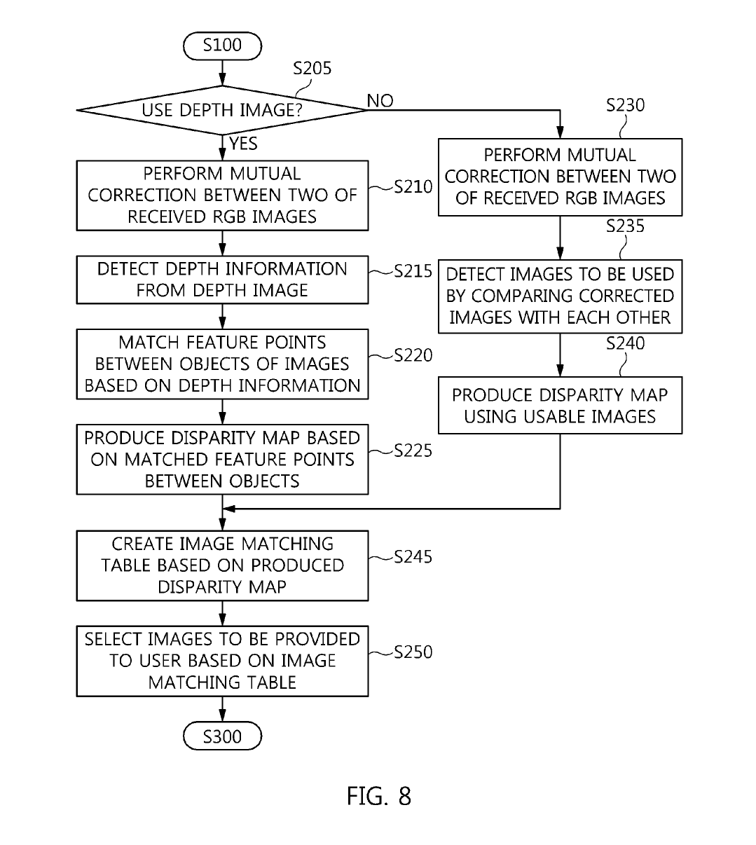

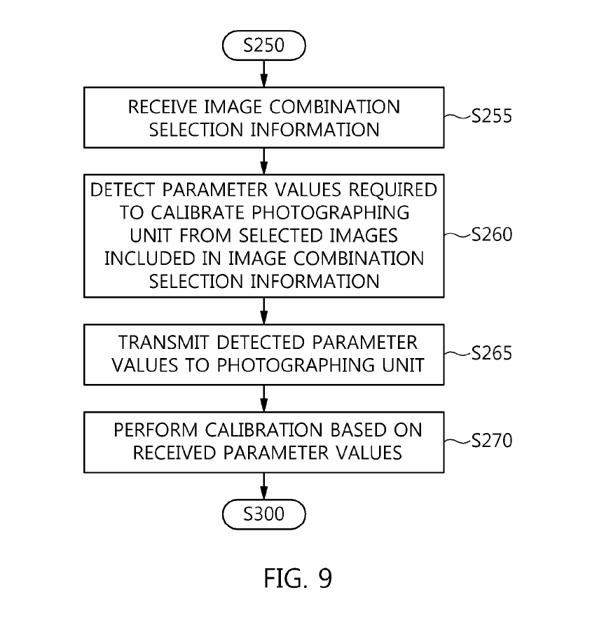

Hereinafter, an image processing method using the 3D image acquisition apparatus according to an embodiment of the present invention will be described in detail with reference to the attached drawings. FIG. 6 is a flowchart showing a 3D image acquisition method according to an embodiment of the present invention. FIG. 7 is a flowchart showing the RGB image and depth image capturing step of FIG. 6, and FIGS. 8 and 9 are flowcharts showing the image analysis and detection step of FIG. 6.

The photographing unit 200 captures RGB images and a depth image at step S100. That is, the photographing unit 200 captures a plurality of RGB images and a depth image using the binocular camera module 220 and the infrared sensor-based camera module 240. This operation will be described in greater detail below with reference to FIG. 7.

The binocular camera module 220 captures two binocular images (that is, RGB images) at step S120. That is, the first binocular camera 222 and the second binocular camera 223 of the binocular camera module 220 capture RGB images, respectively, under photographing conditions based on preset parameters.

Simultaneously with this procedure, the infrared sensor-based camera module 240 captures an RGB image and a depth image at step S140. That is, the infrared radiator 244 radiates infrared rays, receives infrared rays reflected from the infrared receiver 246, and then captures a depth image. The RGB sensor 245 captures an RGB image under photographing conditions based on preset parameters. Here, the parameters are values set after being previously received from the image acquisition unit 300 through the first communication cable 228 and the second communication cable 248. In this case, the parameters include internal parameters and external parameters. Here, the external parameters, which are parameters required to control external factors such as the movement and rotation of the binocular cameras, are composed of signals required to control the InterOcular Distance (IOD) of the first support 221, convergence angle, camera movement, etc. The internal parameters, which are parameters required to control the internal factors of the binocular cameras, are composed of signals required to control a focal length, photographing settings, etc.

The photographing unit 200 transmits the three RGB images and the depth image captured by the binocular camera module 220 and the infrared sensor-based camera module 240 to the image acquisition unit 300 at step S160. That is, the first binocular camera 222 of the binocular camera module 220 transmits the captured RGB image to the image acquisition unit 300 through the first image cable 226. The second binocular camera 223 of the binocular camera module 220 transmits the captured RGB image to the image acquisition unit 300 through the second image cable 227. The infrared sensor-based camera 242 transmits the captured depth image and RGB image to the image acquisition unit 300 through the third image cable 247.

The image acquisition unit 300 analyzes the captured RGB images and the depth image, and detects images to be provided to the user at step S200. This operation will be described in detail below with reference to FIG. 8.

The image acquisition unit 300 determines whether to use the depth image input from the photographing unit 200. That is, the image acquisition unit 300 determines whether to use the depth image, based on the preset amount of information. In this case, the image acquisition unit 300 determines to use the corresponding depth image if the amount of information included in the depth image exceeds the preset amount of information.

Accordingly, the image acquisition unit 300 determines to use the images (that is, the depth image and the RGB image) captured by the infrared sensor-based camera module 240 in an indoor area, and to use the images (that is, two RGB images) captured by the binocular camera module 220 in an outdoor area.

If it is determined to use the depth image (Yes at step S205), the image acquisition unit 300 performs mutual correction between two of the received RGB images by using the two RGB images at step S210. That is, the image acquisition unit 300 processes mutual correction between two RGB images respectively captured by the first binocular camera 222 and the second binocular camera 223, or between two RGB images respectively captured by the first binocular camera 222 and the RGB sensor 245 of the infrared sensor-based camera module. In this case, the image acquisition unit 300 extracts camera parameters for any one RGB image via the matching of feature points between the two RGB images. The image acquisition unit 300 corrects information such as the scale and rotation of the corresponding RGB image so that the RGB image has the same scale and rotation as those of the other RGB image based on the extracted camera parameters.

The image acquisition unit 300 detects depth information from the received depth image at step S215, and matches feature points between the objects of the images, based on the detected depth information at step S220. That is, the image acquisition unit 300 divides each of images to be compared with each other into individual objects of interest, based on the depth information detected from the depth image, and matches feature points between the objects of the respective images.

The image acquisition unit 300 produces a disparity map based on the matched feature points between the objects at step S225. Here, the image acquisition unit 300 may utilize the depth information as basic verification data (ground truth) upon producing a disparity map between the RGB images captured by the binocular camera module 220. By means of this, correction performed under a condition in which depth information is not present must use all of the global features of the images, but if the depth information is present, each image may be divided into respective objects of interest, and feature points between the objects in the RGB images may be matched, thus enabling correction to be more elaborately processed.

Meanwhile, if it is determined not to use the depth image (No at step S205), the image acquisition unit 300 performs mutual correction between two of the received RGB images at step S230. That is, the image acquisition unit 300 processes mutual correction between two RGB images respectively captured by the first binocular camera 222 and the second binocular camera 223 or between two RGB images respectively captured by the first binocular camera 222 and the RGB sensor 245 of the infrared sensor-based camera module. Here, the image acquisition unit 300 extracts camera parameters for any one RGB image via the matching of feature points between the two RGB images. The image analysis unit 320 corrects information such as the scale and rotation of the corresponding RGB image so that the RGB image has the same scale and rotation as those of the other RGB image based on the extracted camera parameters.

The image acquisition unit 300 detects images to be used via the comparison between the corrected images at step S235. That is, the image acquisition unit 300 determines whether to use the corrected images depending on whether the corrected images are aligned with each other. In this case, the image acquisition unit 300 determines to use the corrected images as a stereoscopic image if the corrected images are aligned with each other. If the corrected images are not aligned with each other, image acquisition unit 300 determines not to use the corrected images as a stereoscopic image. Here, since the RGB images captured by the first binocular camera 222 and the second binocular camera 223 may always be aligned with each other via calibration, the image acquisition unit 300 analyzes only whether the images captured by the first binocular camera 222 and the RGB sensor 245 are aligned with each other.

The image acquisition unit 300 produces a disparity map using usable images at step S240. That is, the image acquisition unit 300 compares images determined to be usable at step S235, among the corrected images, with each other and then produces the disparity map. The image acquisition unit 300 sets the produced disparity map to the depth information of the images. In this case, the image acquisition unit 300 compares all global features of the corrected images with each other, and produces the disparity map.

The image acquisition unit 300 creates an image matching table based on the disparity map, produced at step S225 or S240, at step S245. That is, the image acquisition unit 300 creates an image matching table based on a disparity map between the RGB images captured by the first binocular camera 222 and the RGB sensor 245, a disparity map between the RGB images captured by the second binocular camera 223 and the RGB sensor 245, and a disparity map between the RGB images captured by the first binocular camera 222 and the second binocular camera 223. In this case, the image matching table shows indices indicating whether the corrected images are usable, and indicates the usability of a vertical camera-based binocular image, a horizontal camera-based binocular image, and depth/disparity-based depth images by indices.

The image acquisition unit 300 selects images to be provided to the user based on the created image matching table at step S250. In this case, the image acquisition unit chiefly selects a basic combination, that is, RGB images captured by the binocular camera module 220, and the RGB image and the depth image captured by the infrared sensor-based camera module 240. The image acquisition unit selects a combination of RGB images captured by the first binocular camera 222 and the RGB sensor 245 so as to perform close-up photographing. The image acquisition unit may also select a disparity map between the depth image and the RGB images captured by the binocular camera module 220 upon performing indoor photographing.

The image acquisition unit 300 outputs the detected images to the 3D image display device 400 at step S300. Accordingly, the 3D image display device 400 provides 3D images to the user using the received images.

In this case, at the image analysis and detection step, the calibration of the binocular camera module 220 and the infrared sensor-based camera module 240 may be preformed based on the corrected images. This procedure will be described in greater detail below with reference to FIG. 9.

The image acquisition unit 300 receives image combination selection information from the 3D image display device 400 at step S255. That is, the 3D image display device 400 receives image combination selection information including two or more images from among the images transmitted at step S300 via the user's input. In this case, the 3D image display device 400 receives image combination selection information such as a combination of binocular images or a combination of a binocular image and a depth image. The 3D image display device 400 transmits the received image combination selection information to the image acquisition unit 300.

The image acquisition unit 300 detects parameter values for the calibration of the photographing unit 200 from the images included in the received image combination selection information at step S260.

Since at least one of the images included in the image combination selection information is a corrected image, the image acquisition unit 300 detects parameter values required to calibrate a camera (that is, the first binocular camera 222, the second binocular camera 223, or the RGB sensor 245) which captured the corrected image. Here, the parameter values include at least one of internal parameters and external parameters.

The image acquisition unit 300 transmits the detected parameter values to the photographing unit 200 at step S265. That is, the image acquisition unit 300 transmits the detected parameter values to the photographing unit 200 so as to calibrate the binocular camera module 220 and the infrared sensor-based camera module 240. In this case, the image acquisition unit 300 transmits the parameter values to the binocular camera module 220 through the first communication cable. The image acquisition unit 300 transmits the parameter values to the infrared sensor-based camera module 240 through the second communication cable.

The photographing unit 200 performs calibration based on the parameter values received from the image acquisition unit 300 at step S270. That is, the binocular camera module 220 and the infrared sensor-based camera module 240 control the shafts and the cameras depending on the received parameter values.

As described above, the 3D image acquisition apparatus and the image processing method using the apparatus are advantageous in that, in order to improve limitations caused by the exclusive use of an infrared sensor device or a binocular camera device in conventional technology, two different types of camera devices are integrated and implemented on a single support, so that a high-quality depth-based image modeling system may be implemented using an inexpensive infrared sensor device and inexpensive binocular camera devices without using expensive LIDAR equipment.

Further, conventional binocular camera devices are problematic in that an orthogonal or parallel support must be used depending on the distance to an object of interest, but the 3D image acquisition apparatus and the image processing method using the apparatus according to the present invention are advantageous in that the same effect as that obtained when an orthogonal support and a parallel support are simultaneously used may be obtained.

Furthermore, the 3D image acquisition apparatus and the image processing method using the apparatus are advantageous in that depth image-based elaborated object processing can be performed through the use of an infrared sensor in indoor and night environments, thus, compared to conventional methods, much more rapidly and exactly processing automatic control for camera parameters and supports.

Although embodiments of the present invention have been described, the present invention may be modified in various forms, and those skilled in the art will appreciate that various modifications and changes may be implemented without departing from the spirit and scope of the accompanying claims.

What is claimed is:

1. A three-dimensional (3D) image acquisition apparatus, comprising:
photographing unit for capturing binocular images via a plurality of cameras and capturing an RGB image and a depth image based on an infrared sensor; and
image acquisition unit for correcting at least one pair of images among the binocular images and the RGB image, based on whether to use the depth image captured by the photographing unit, and then acquiring images to be provided to a user.

2. The 3D image acquisition apparatus of claim 1, wherein the photographing unit comprises:
a first support;
a binocular camera module comprising a first binocular camera arranged on a first surface of the first support and configured to capture a binocular image, and a second binocular camera arranged on the first surface of the first support while being spaced apart from the first binocular camera, and configured to capture a binocular image;
a second support provided with a first surface coupled to a second surface of the first support; and
an infrared sensor-based camera module comprising an infrared sensor-based camera arranged on a second surface of the second support and configured to capture the depth image and the RGB image.

3. The 3D image acquisition apparatus of claim 2, wherein the binocular camera module further comprises:
a first image cable connected at a first end thereof to the first binocular camera and at a second end thereof to the image acquisition unit, and configured to transmit the image captured by the first binocular camera to the image acquisition unit; and
a second image cable connected at a first end thereof to the second binocular camera and at a second end thereof to the image acquisition unit, and configured to transmit the image captured by the second binocular camera to the image acquisition unit.

4. The 3D image acquisition apparatus of claim 2, wherein the binocular camera module further comprises:
a first communication cable configured to receive parameters from the image acquisition unit;
a first shaft arranged on the first surface of the first support and configured to move and rotate the first binocular camera based on the parameters received through the first communication cable; and
a second shaft arranged on the first surface of the first support and configured to move and rotate the second binocular camera based on the parameters received through the first communication cable.

5. The 3D image acquisition apparatus of claim 2, wherein the infrared sensor-based camera module further comprises a third image cable connected at a first end thereof to the infrared sensor-based camera and at a second end thereof to the image acquisition unit, and configured to transmit the depth image and the RGB image captured by the infrared sensor-based camera to the image acquisition unit.

6. The 3D image acquisition apparatus of claim 2, wherein the infrared sensor-based camera module further comprises:
a third communication cable configured to receive parameters from the image acquisition unit; and
a third shaft arranged on the second surface of the second support and configured to move and rotate the infrared sensor-based camera based on the parameters received through the third communication cable.

7. The 3D image acquisition apparatus of claim 2, wherein an interval between the first binocular camera and the second binocular camera is formed to be wider than an interval between the first binocular camera and an RGB sensor of the infrared sensor-based camera module.

8. The 3D image acquisition apparatus of claim 2, wherein:
an optical axis between the first binocular camera and the second binocular camera is linearly arranged, and an optical axis between the first binocular camera and an RGB sensor of the infrared sensor-based camera is linearly arranged, and
the optical axis between the first binocular camera and the second binocular camera and the optical axis between the first binocular camera and the RGB sensor are orthogonal to each other.

9. The 3D image acquisition apparatus of claim 1, wherein the image acquisition unit comprises:
an image analysis unit for mutually correcting two of RGB images received from the photographing unit based on whether to use the depth image received from the photographing unit, producing a disparity map based on corrected RGB images and the depth image, and creating an image matching table based on the disparity map; and
an image selection unit for selecting images to be provided to the user based on the image matching table.

10. The 3D image acquisition apparatus of claim 9, wherein the image analysis unit determines whether to use the depth image captured by the photographing unit, based on an amount of information included in the depth image.

11. The 3D image acquisition apparatus of claim 10, wherein the image analysis unit is configured to, if it is determined not to use the depth image, mutually correct the binocular images captured by the binocular camera module, or any one of the binocular images captured by the binocular camera module and the RGB image captured by the infrared sensor-based camera module, determine whether to use the corrected images depending on whether the corrected images are aligned with each other, produce a disparity map, and create an image matching table based on the produced disparity map.

12. The 3D image acquisition apparatus of claim 10, wherein the image analysis unit is configured to, if it is determined to use the depth image, mutually correct the binocular images captured by the binocular camera module, or any one of the binocular images captured by the binocular camera module and the RGB image captured by the infrared sensor-based camera module, match feature points between objects of the images based on depth information detected from the depth image, produce a disparity map, and create an image matching table based on the produced disparity map.

13. The 3D image acquisition apparatus of claim 9, wherein:
the image selection unit calculates parameter values based on images included in image combination selection information input from a 3D image display device, and
the image acquisition unit further comprises a parameter adjustment unit for transmitting the parameter values detected by the image selection unit to the binocular camera module and the infrared sensor-based camera module, and calibrating the binocular camera module and the infrared sensor-based camera module.

14. An image processing method using a 3D image acquisition apparatus, comprising:
capturing, by photographing unit, binocular images via a plurality of binocular cameras and capturing an RGB image and a depth image via an infrared sensor-based camera;
analyzing, by image acquisition unit, the captured binocular images, RGB image, and depth image, and detecting images to be provided to a user; and
transmitting, by the image acquisition unit, the detected images to a 3D image display device.

15. The image processing method of claim 14, wherein capturing comprises:
capturing, by the photographing unit, two binocular images;
capturing, by the photographing unit, the RGB image and the depth image; and
transmitting, by the photographing unit, the captured two binocular images, RGB image, and depth image to the image acquisition unit.

16. The image processing method of claim 14, wherein detecting comprises:
determining, by the image acquisition unit, whether to use the depth image received from the photographing unit,
wherein determining is configured to determine whether to use the depth image, based on an amount of information included in the depth image.

17. The image processing method of claim 16, wherein detecting further comprises, if it is determined to use the depth image at determining,
mutually correcting, by the image acquisition unit, two images of the binocular images and the RGB image;
matching, by the image acquisition unit, feature points between objects of the images, based on the depth information detected from the depth image; and
creating, by the image acquisition unit, an image matching table based on a disparity map produced from the matched feature points between the objects.

18. The image processing method of claim 16, wherein detecting further comprises, if it is determined not to use the depth image at determining:
mutually correcting, by the image acquisition unit, two images of the binocular images and the RGB image;
determining, by the image acquisition unit, whether to use the corrected images, depending on whether the corrected images are aligned with each other, and then producing a disparity map; and
creating, by the image acquisition unit, an image matching table based on the produced disparity map.

19. The image processing method of claim 14, further comprising calibrating, by the image acquisition unit, the plurality of binocular cameras and the infrared sensor-based camera.

20. The image processing method of claim 19, wherein calibrating comprises:
receiving, by the image acquisition unit, image combination selection information from the 3D image display device;
detecting, by the image acquisition unit, parameter values required to calibrate the plurality of binocular cameras and the infrared sensor-based camera, from images included in the received image combination selection information; and
transmitting, by the image acquisition unit, the detected parameter values to the photographing unit.
